(19) United States
(12) Patent Application Publication
(10) Pub. No.: US 2018/0219250 A1
(43) Pub. Date: Aug. 2, 2018

(54) METHOD FOR FORMING A CELL OF A LITHIUM-ION BATTERY PROVIDED WITH A POSITIVE ELECTRODE COMPRISING A SACRIFICIAL SALT

(71) Applicant: RENAULT s.a.s, Boulogne-Billancourt (FR)

(72) Inventors: Bruno DELOBEL, Paris (FR); Mohamed CHAKIR, Saint-Germain-Les-Arpajon (FR); Yvan REYNIER, Saint -Egreve (FR); Florence MASSE, PARIS (FR)

(73) Assignee: RENAULT s.a.s, Boulogne-Billancourt (FR)

(21) Appl. No.: 15/756,625

(22) PCT Filed: Aug. 24, 2016
(86) PCT No.: PCT/FR2016/052111

§ 371 Date: Mar. 1, 2018

(30) Foreign Application Priority Data
Sep. 2, 2015 (FR) 1558138

(51) Int. Cl. H01M 10/0525; H01M 10/058; H01M 10/615; H01M 4/1393; H01M 4/1395; H01M 4/583; H01M 4/62; H01M 4/505; H01M 4/525; H01M 2/14

(52) U.S. Cl. CPC H01M 10/0525; H01M 10/058; H01M 10/615; H01M 4/1393; H01M 4/1395; H01M 2004/028; H01M 4/622; H01M 4/505; H01M 4/525; H01M 2/14; H01M 4/5835

(57) ABSTRACT

A method for forming a cell of a lithium-ion battery comprising a material for a positive electrode having a pore ratio of between 20 and 35% and comprising at least one sacrificial salt, a material for a negative electrode, a separator and an electrolyte, comprising the following successive steps: (a) heating the cell to a temperature T of between 30 and 45° C.; and (b) charging the cell to a potential lower than or equal to 4.8 V, preferably between 4.6 and 4.8 V, even more preferably between 4.7 and 4.8 V.

The invention relates to the general field of lithium-ion rechargeable batteries.

The invention relates more precisely to a method for forming a battery cell comprising a positive electrode material comprising at least one sacrificial salt.

Conventionally, Li-ion batteries comprise one or more cathodes, one or more anodes, an electrolyte and a separator consisting of a porous polymer or of any other suitable material for preventing any direct contact between the electrodes.

Li-ion batteries are already widely used in numerous mobile applications. This trend can be explained notably by volume and mass energy densities that are much greater than those of the conventional nickel-cadmium (Ni—Cd) and nickel-metal hydride (Ni-MH) accumulators, absence of a memory effect, low self-discharge relative to other accumulators as well as lowering of the kilowatt-hour costs associated with this technology.

Nevertheless, improvement of this technology is necessary for gaining new markets such as electric and hybrid vehicles that often require high energy density, high power density and long life.

Once the Li-ion battery cell is activated, i.e. when the cell has been assembled and the cell has been impregnated with the electrolyte, thermodynamic reactions are involved during the first cycle of charging said cell, and the first exchanges of lithium ions between the electrodes take place. Products resulting from these reactions accumulate on the surface of the electrodes to form a so-called “Solid Electrolyte Interphase” (SEI) layer. This layer is an essential element for the proper operation of the Li-ion battery, because it not only conducts the lithium ions very well, it also has the advantage of stopping the catalytic decomposition of the solvent.

However, it is known that batteries lose between 5 and 20% of the potential capacity of their positive electrode, thus limiting the energy density of said batteries at the time of formation of this layer, during which the negative electrode consumes lithium irreversibly.

Several approaches have been envisaged for solving this problem.

Thus, metallic lithium has been added to the negative electrode to compensate the irreversible consumption of lithium during the first cycle of charging, as is described in document JP 2012/009209. However, using lithium in the metallic state poses a great many problems as it reacts violently with moisture and the polar solvents commonly used in the application of electrode inks (generally water or N-methylpyrrolidone (NMP)).

A sacrificial salt may also be added to the positive electrode, as is described in document FR 2 961 634. A particular salt of lithium oxalate is disclosed in this patent, but it is judged to be unsuitable as it oxidizes at a potential that is too high.

Moreover, additives have been added to the electrolyte, such as vinylene carbonate, as envisaged by Aurbach et al. in “On the use of vinylene carbonate (VC) as an additive to electrolyte solutions for Li-ion batteries” Electrochemica Acta 47 (2002), 1423-1439, or propanesultone carbonate as envisaged by Zuo et al. in “Electrochemical reduction of 1,3-propane sultone on graphite electrodes and its application in Li-ion batteries” Electrochemica and Solid-State Letters 9 (4), A196-A199 (2006), to improve the quality of the SEI, which thus has an influence on the service life of the cell.

However, the major drawback of using additives is associated with consumption of the lithium of the positive electrode for forming the SEI layer. This has an impact on the initial capacity of the cell but also on the total duration of the life cycle of said cell.

The present invention aims to propose a solution for solving the problem connected with the irreversible capacity due to the first cycle of formation of the Li-ion batteries, allowing the durability of said batteries to be increased.

According to the invention, a method for forming a lithium-ion battery cell comprising a positive electrode material having a level of porosity from 20 to 35% and comprising at least one sacrificial salt, a negative electrode material, a separator and an electrolyte, comprises the following successive steps:

(a) heating the cell to a temperature T₁ in the range from 30 to 45° C.;

(b) charging the cell to a potential less than or equal to 4.8 V, preferably from 4.6 to 4.8 V, more preferably from 4.7 to 4.8 V.

The method according to the invention gives a considerable reduction in the loss of capacity of the positive electrode of the Li-ion battery cell during the first cycle of charging, thus leading to an increase in the life of said battery.

Other advantages and features of the invention will become clearer on examining the detailed description and the appended drawings, in which:

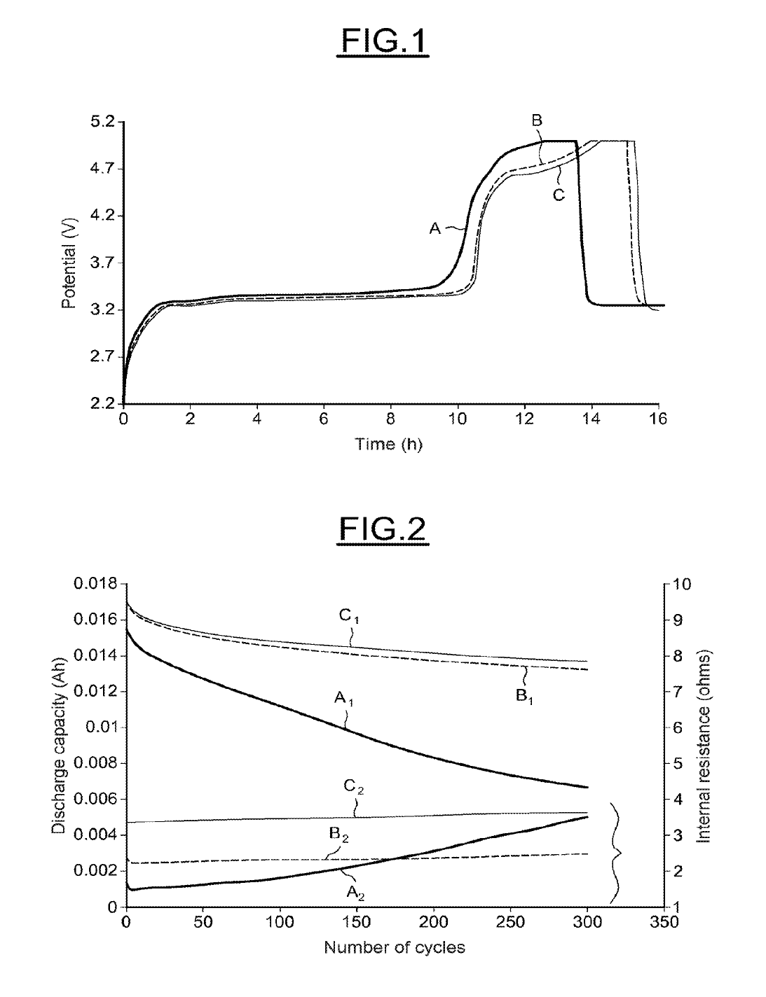

FIG. 1 is a graph showing the variation of the potential of three Li-ion battery cells as a function of time;

FIG. 2 is a graph showing the variation of the discharge capacity and the variation of the internal resistance of three Li-ion battery cells, as a function of the number of cycles;

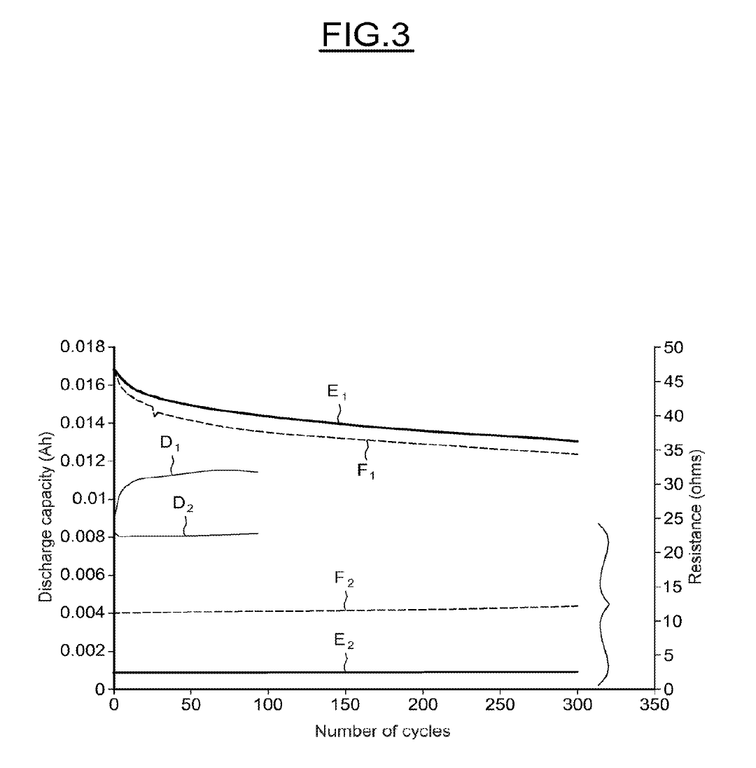

FIG. 3 is a graph showing the variation of the discharge capacity and the variation of the resistance of three Li-ion battery cells having particular levels of porosity, as a function of the number of cycles.

In the description of the invention, the term “based on” is a synonym of “predominantly comprising”.

It should in addition be stated that the expressions “from . . . to . . . ” used in the present description are to be understood as including each of the limits mentioned.

As explained above, the method of formation according to the invention relates to a lithium-ion battery cell comprising a positive electrode material having a level of porosity in the range from 20 to 35% and comprising at least one sacrificial salt, a negative electrode material, a separator and an electrolyte.

The true density of the electrode (Dr) is calculated from the mass and the thickness of the electrode deposit. The theoretical (compacted) density of deposition (Dth) can be calculated from the densities of each component. Thus, the level of porosity (tP, expressed as a percentage), defined as the proportion of empty space in the electrode, is given by the following equation (I):

tP=(1−Dr/Dth)*100 (I).

The sacrificial salt is a compound capable of oxidizing during the first cycle of charging the assembled battery cell, to a potential for example in the range from 2 to 5 V. On oxidation, the sacrificial salt produces ions (Li⁺ ions when the sacrificial salt is a salt of the Li⁺ cation), which penetrate into the electrolyte. Said salt is then said to have pre-lithiation properties. Said ions compensate, at least partially, the capacity lost during formation of the SEI layer on the negative electrode.

Moreover, the oxidized salt creates porosity within the electrode, which must be finely controlled to prevent loss of performance of the Li-ion accumulator. In fact, excessive porosity limits the electronic contacts between particles and increases the resistance of the electrochemical cell.

According to a particular embodiment of the invention, the sacrificial salt is selected from Li₂C₂O₄, LiN₃, Li₂C₃O₅, Li₂C₄O₆, Li₂C₃O₃, Li₂C₄O₄, Li₂C₅O₅, Li₂C₆O₆, Li₂N₄O₂ and [Li₂N₂C₂O₂]ₙ, n being from 1 to 100, preferably from 1 to 50, more preferably from 1 to 10, and preferably Li₂C₂O₄.

Lithium oxalate is a salt with a capacity of 545 mAh/g, stable in air, which may be incorporated in a positive electrode formulation. Between 4.5 and 5.5 V vs. Li+/Li, it oxidizes, releasing carbon dioxide and two lithium ions. The lithium ions released are able to compensate the irreversible first-charge capacity of a lithium-ion battery cell, thus increasing its initial capacity. The carbon dioxide is evacuated at the end of formation, and its mass (a function of the level of oxalate) therefore does not contribute to that of the battery.

According to another feature of the invention, the positive electrode material comprises from 3 to 10 wt % of sacrificial salt, preferably from 3 to 7%, more preferably from 4 to 6%, relative to the total weight of the positive electrode.

Advantageously, the level of porosity of the positive electrode is from 25 to 35%.

Preferably, the positive electrode material comprises an active material selected from:
the phosphates of olivine structure LiᵥT^{a}PO₄, in which 0≤v≤1 and T^{a} is selected from Fe, Ni, Co, Mn and mixtures thereof;
the materials of formula Li₁₊ᵤ(MₐD_{b})₁₋ᵤO₂, in which 0.01≤u≤0.33, M is selected from Ni, Mn, Co and mixtures thereof, D represents one or more doping metals selected from Na, Zn, Cd, Mg, Ti, Ca, Zr, Sr, Ba, Al and K, 0≤b≤0.05 and a+b=1; and
the materials of spinel structure selected from LiMn₂O₄ and LiNi_{0.5}Mn_{1.5}O₄,

more preferably the phosphates of olivine structure, even more preferably LiFePO₄.

The oxidation potential of lithium oxalate is too high to be used with some positive electrodes, such as the electrode based on LiNiₓMn_{y}Co_{z}O₂ (NMC), where x+y+z=1, the electrode based on LiNi_{0.8}Co_{0.15}Al_{0.05}O₂ (NCA) or the electrode based on LiCoO₂ (LCO), whose structure is unstable above 4.5 V.

However, with materials of the spinel type (LiMn₂O₄ or LiNi_{0.5}Mn_{1.5}O₄) or lithiated phosphate Li(Fe,Mn,Ni)PO₄, or else of the type (Li₁₊ₓMO₂), potentials of 5 V may be envisaged, because either the activity range of these materials coincides with the activation potential of the oxalate, or it is totally unconnected. For example, with a material of the LiFePO₄ type, the redox activity is between 3.4 V and 3.5 V, and it does not oxidize above that. By adding the oxalate salt, it can be oxidized at 5 V without any risk of disturbing the structure of the active material.

It is known, however, that the standard electrolytes of Li-ion batteries (based on carbonates) begin to oxidize above 4 V, a phenomenon that becomes predominant beyond 5 V. It is therefore desirable to reduce the maximum charge potential as much as possible to avoid these parasitic reactions.

Preferably, the positive electrode material comprises one or more binders.

Preferably, the binder or binders are organic polymers, preferably polybutadiene-styrene latices, polyesters, polyethers, methyl methacrylate polymer derivatives, polymer derivatives of acrylonitrile, carboxymethylcellulose and derivatives thereof, polyvinyl acetates or polyacrylate acetate, polyvinylidene fluoride, and mixtures thereof.

According to a variant of the method according to the invention, the negative electrode material is based on graphite. The graphitic carbon may be selected from the synthetic graphitic carbons and natural graphitic carbons starting from natural precursors followed by purification and/or posttreatment. Other carbon-based active materials may be used such as pyrolytic carbon, amorphous carbon, activated carbon, coke, coal-tar pitch and graphene. Mixtures of graphite with one or more of these materials are possible. Materials having a core-shell structure may be used when the core comprises high-capacity graphite and the shell comprises a carbon-based material protecting the core from degradation connected with the repeated effect of Li-ion insertion/deinsertion.

Advantageously, the negative electrode material is based on a composite selected from a composite of silicon/graphite, tin/graphite, tin oxide/graphite, such as SnO₂/graphite, and mixtures thereof, preferably a silicon/graphite composite.

Preferably, the silicon/graphite composite comprises from 0 to 30 wt % of silicon relative to the total weight of the composite, more preferably from 0 to 15%, even more preferably from 5 to 10%.

Preferably, the separator is located between the electrodes and performs the role of electrical insulator. Several materials may be used as separators. The separators generally consist of porous polymers, preferably polyethylene and/or polypropylene.

Advantageously, the separator used is the Celgard® 2325 separator, which is a single-layer microporous membrane with a thickness of 25 μm consisting of polypropylene.

Preferably, said electrolyte is a liquid electrolyte.

According to another feature of the invention, said electrolyte comprises one or more lithium salts.

Advantageously, said lithium salt or salts are selected from lithium bis[(trifluoromethyl)sulfonyl]imide (LiN(CF₃SO₂)₂), lithium trifluoromethane sulfonate (LiCF₃SO₃), lithium bis(oxalato)borate (LiBOB), lithium bis(perfluoroethylsulfonyl)imide (LiN(CF₃CF₂SO₂)₂), LiClO₄, LiAsF₆, LiPF₆, LiBF₄, LiI, LiCH₃SO₃, LiB(C₂O₄)₂, LiR_{F}SOSR_{F}, LiN(R_{F}SO₂)₂, LiC(R_{F}SO₂)₃, R_{F} being a group selected from a fluorine atom and a perfluoroalkyl group comprising from one to eight carbon atoms.

Preferably, the electrolyte comprises a mixture of solvents comprising ethylene carbonate and at least one solvent selected from ethyl and methyl carbonate, dimethyl carbonate, diethyl carbonate and mixtures thereof.

According to a particular embodiment of the invention, the electrolyte comprises a mixture of ethylene carbonate, dimethyl carbonate and ethyl and methyl carbonate in proportions of 1/1/1 by volume with the lithium salt LiPF₆ at 1M.

As mentioned above, step (a) of the method of formation according to the invention consists of heating the cell to a temperature T₁ from 30 to 45° C.

Preferably, the temperature T₁ is in the range from 35 to 45° C., and more preferably the temperature T₁ is 40° C.

As explained above, step (b) of the method of formation according to the invention consists of charging the cell to a potential less than or equal to 4.8 V, preferably from 4.6 to 4.8 V, more preferably from 4.7 to 4.8 V. More preferably, charging of the cell is performed up to a potential from 4.75 to 4.8 V.

According to a particular embodiment of the invention, a method of formation according to the invention, applied to a battery cell comprising a positive electrode material having a level of porosity in the range from 20 to 35%, preferably of 35%, said material comprising an active material of formula LiFePO₄ and 5 wt % of lithium oxalate relative to the total weight of the positive electrode, a negative electrode material, a separator and an electrolyte, comprises the following successive steps:

(a) heating the cell to a temperature T₁ of 40° C.;

(b) charging the cell up to a potential from 4.7 to 4.8 V, preferably 4.8 V.

### EXAMPLES

### 1. Preparation of a Lithium-ion Battery Cell Comprising a Positive Electrode Comprising Lithium Oxalate

1.1 Preparation of a Positive Electrode

An active material of formula LiFePO₄ is used. The positive electrode is prepared by mixing 85 wt % of active material, 5 wt % of Super P® carbon additive, 5 wt % of polyvinylidene fluoride in N-methyl-2-pyrrolidone (NMP) and 5 wt % of lithium oxalate Li₂C₂O₄.

The electrode is made by depositing the mixture on an aluminum foil with a thickness of 20 μm. The electrode is dried and compressed by calendering at 80° C.

1.2 Preparation of a Negative Electrode

A negative electrode based on a silicon/graphite composite (Hitachi Chemical) was prepared. The negative electrode is prepared by mixing 94 wt % of active material, 2 wt % of carboxymethylcellulose (CMC), and 4 wt % of Styrofan® latex, which is a carboxylated styrene-butadiene copolymer.

The electrode is made by depositing the mixture on a copper foil with a thickness of 10 μm. The electrode is dried and compressed by calendering at 80° C.

1.3 Separator

The Celgard® 2325 separator is used in order to prevent any short-circuiting between the positive electrode and the negative electrode during the charge/discharge cycles. The Celgard® 2325 separator is a single-layer microporous membrane with a thickness of 25 μm consisting of polypropylene.

1.4 Electrolyte

The electrolyte used consists of 1M of lithium salt LiPF₆ dissolved in a mixture of ethylene carbonate, dimethyl carbonate and ethyl and methyl carbonate in proportions of 1/1/1 by volume.

1.5 Electrochemical Cell

A lithium-ion battery cell is assembled by stacking the positive electrode, with an area of 10 cm², and the negative electrode as described above, the separator, as described above, being located between the electrodes, and then the cell is impregnated with the electrolyte, as described above.

### 2. Electrochemical Performance of the Li-ion Battery Cell

2.1 Evaluation of the Variation of the Potential of the Li-ion Battery Cell as a Function of Time

Method

Three particular methods of formation, called method A, method B and method C respectively, were applied to the Li-ion battery cell as prepared above.

Method A is applied to the Li-ion battery cell called cell A. Method B is applied to the cell called cell B and method C is applied to the cell called cell C.

The comparative method A comprises a step of heating cell A to 22° C., then a step of charging cell A up to a potential of 4.8 V.

Method B according to the invention comprises a step of heating cell B to 40° C., then a step of charging cell B up to a potential of 4.8 V.

The comparative method C comprises a step of heating cell C to 50° C., then a step of charging cell C up to a potential of 4.8 V.

Result

In FIG. 1, curves A, B and C correspond to the variation of the potential of cells A, B and C, respectively.

FIG. 1 clearly shows that cells B and C display electrochemical behavior different from that of cell A.

When the potential is close to 3.2-3.3 V, the 3 curves have a plateau that corresponds to the redox activity of the active material of formula LiFePO₄.

When the potential is close to 4.8 V, curve A has a plateau that corresponds to the redox activity of lithium oxalate. However, curves B and C have a plateau that also corresponds to the redox activity of lithium oxalate, when the potential is of the order of 4.5 V.

Thus, FIG. 1 shows that an increase in temperature from 22 to 40-50° C. allows activation of lithium oxalate at a lower potential, so that it is possible to lower the end-of-charge potential to 4.8 V.

This represents a considerable advantage, because the conventional Li-ion battery electrolytes, i.e. based on carbonate solvents, are unstable at a potential above 5 V.

2.2 Evaluation of the Variation of the Discharge Capacity and Internal Resistance of the Li-ion Battery Cell as a Function of the Number of Cycles

Method

The method is identical to that given in paragraph 2.1.

Result

In FIG. 2, curve A1 corresponds to the variation of the discharge capacity of cell A and curve A2 corresponds to the variation of the internal resistance of cell A. Curve B1 corresponds to the variation of the discharge capacity of cell B and curve B2 corresponds to the variation of the internal resistance of cell B. Curve C1 corresponds to the variation of the discharge capacity of cell C and curve C2 corresponds to the variation of the internal resistance of cell C.

FIG. 2 shows that a low discharge capacity is observed after 300 cycles (curve A1), and that the internal resistance of cell A increases significantly with the number of cycles (curve A2).

However, good discharge capacities are observed for cells B and C according to curves B1 and C1. Cell C has a higher internal resistance (curve C2) than that of cell B (curve B2). In fact, an excessive temperature and the potential of 4.8 V lead to high internal resistance owing to degradation of the electrolyte on activation of the sacrificial salt, lithium oxalate.

Thus, it is clearly shown that heating the cell to a temperature around 40° C., in the range from 30 to 45° C., is ideal for obtaining, simultaneously, low, stable internal resistance, a good discharge capacity and good cycling behavior.

2.3 Evaluation of the Variation of the Discharge Capacity and Internal Resistance of Li-ion Battery Cells having Particular Levels of Porosity, as a Function of the Number of Cycles

Method

The method of formation B according to the invention was applied to three Li-ion battery cells, called cell D, cell E and cell F, each comprising a positive electrode, each of the positive electrodes having three different levels of porosity, of 47%, 35% and 42% respectively, obtained by three different levels of calendering.

Thus, a comparative method of formation D was applied to cell D; a method of formation E according to the invention was applied to cell E; and a comparative method of formation F was applied to cell F.

Result

In FIG. 3, curve D1 corresponds to the variation of the discharge capacity of cell D and curve D2 corresponds to the variation of the resistance of cell D. Curve E1 corresponds to the variation of the discharge capacity of cell E and curve E2 corresponds to the variation of the resistance of cell E. Curve F1 corresponds to the variation of the discharge capacity of cell F and curve F2 corresponds to the variation of the resistance of cell F.

FIG. 3 shows that cell D has a high internal resistance (curve D2), a low discharge capacity and poor cycling behavior (curve D1).

Cell E has a low resistance (curve E2) and a good discharge capacity (curve E1).

Cell F has a relatively high internal resistance (curve F2) and a good discharge capacity (curve F1).

Thus, it is shown that a level of porosity of 35% in the positive electrode makes it possible to obtain, simultaneously, low, stable internal resistance, a good discharge capacity and good cycling behavior.

Beyond a level of porosity of 35%, the electrical conductivity of the positive electrode is limited and the resistance of the battery increases dramatically. In fact, the battery performance plummets.

1. A method for forming a lithium-ion battery cell comprising a positive electrode material having a level of porosity in the range from 20 to 35% and comprising a sacrificial salt, a negative electrode material, a separator and an electrolyte, the method comprising:
(a) heating the cell to a temperature T₁ in the range from 30 to 45° C.; and
(b) charging the cell to a potential less than or equal to 4.8 V.

2. The method of claim 1, wherein the sacrificial salt is selected from the group consisting of Li₂C₂O₄, LiN₃, Li₂C₃O₅, Li₂C₄O₆, Li₂C₃O₃, Li₂C₄O₄, Li₂C₅O₅, Li₂C₆O₆, Li₂N₄O₂ and [Li₂N₂C₂O₂]ₙ, n being from 1 to 100.

3. The method of claim 1, wherein the positive electrode material comprises from 3 to 10% by weight of sacrificial salt relative to the total weight of the positive electrode.

4. The method of claim 1, wherein the positive electrode material comprises an active material selected from:
phosphates of olivine structure LiᵥT^{a}PO₄, wherein 0≤v≤1 and T^{a} is selected from Fe, Ni, Co, Mn and mixtures thereof;
materials of formula Li₁₊ᵤ(MₐD_{b})₁₋ᵤO₂, wherein 0.01≤u≤0.33, M is selected from Ni, Mn, Co and mixtures thereof, D represents at least one doping metal selected from Na, Zn, Cd, Mg, Ti, Ca, Zr, Sr, Ba, Al and K, 0≤b≤0.05 and a+b=1; and
materials of spinel structure selected from LiMn₂O₄ and LiNi_{0.5}Mn_{1.5}O₄.

5. The method of claim 1, wherein the positive electrode material comprises a binder.

6. The method of claim 1, wherein the negative electrode material comprises graphite.

7. The method of claim 1, wherein the electrolyte comprises a lithium salt.

8. The method of claim 7, wherein the lithium salt is at least one selected from the group consisting of lithium bis[(trifluoromethyl)sulfonyl]imide (LiN(CF₃SO₂)₂), lithium trifluoromethane sulfonate (LiCF₃SO₃), lithium bis(oxalato)borate (LiBOB), lithium bis(perfluoroethylsulfonyl)imide (LiN(CF₃CF₂SO₂)₂), LiClO₄, LiAsF₆, LiPF₆, LiBF₄, LiI, LiCH₃SO₃, LiB(C₂O₄)₂, LiR_{F}SOSR_{F}, LiN(R_{F}SO₂)₂, and LiC(R_{F}SO₂)₃, R_{F} being a group selected from a fluorine atom and a perfluoroalkyl group comprising from one to eight carbon atoms.

9. The method of claim 1, wherein the electrolyte comprises a mixture of solvents comprising ethylene carbonate and at least one solvent selected from the group consisting of ethyl and methyl carbonate, dimethyl carbonate, diethyl carbonate and mixtures thereof.

10. The method of claim 1, wherein the temperature T₁ is in the range from 35 to 45° C.
